(19) United States
(12) Patent Application Publication
(10) Pub. No.: US 2008/0052402 A1
(43) Pub. Date: Feb. 28, 2008

(54) Method, a Computer Program, a Device, and a System for Protecting a Server Against Denial of Service Attacks

(75) Inventors: Yannick Carlinet, Lannion (FR); Yvon Gourhant, Lannion (FR); Patrick Trabe, Montpellier (FR)

Correspondence Address: OLIFF & BERRIDGE, PLC, P.O. BOX 320850, ALEXANDRIA, VA, 22320-4850, US

(73) Assignee: FRANCE TELECOM, Paris (FR)

(21) Appl. No.: 11/631,672

(22) PCT Filed: Jul. 8, 2005
(86) PCT No.: PCT/FR05/01776

§ 371 Date: Mar. 15, 2007

(30) Foreign Application Priority Data
Jul. 8, 2004 (FR) 0407642

(51) Int. Cl. G06F 15/16

(52) U.S. Cl. 709/229

(57) ABSTRACT

The invention relates in particular to a method of protecting a server (10) against denial of service attacks wherein, when setting up a communication session between a client (26) and the server, the setting up of that session being requested by the client for the provision of a service:

the server receives (52) a request to provide service sent by the client;

the server sends (54) an agreement to provide service to the client;

the server waits (56) for an acknowledgement of the agreement from the client within a time period determined beforehand by the server.

During this exchange of data, intermediate equipment (30) intercepts the data exchanged between the client and the server. Furthermore, if a criterion determined beforehand by the intermediate equipment is satisfied during this exchange of data, the intermediate equipment interrupts the setting up of the session requested by the client.

The present invention relates to a method, a computer program, a device, and a system for protecting a server against denial of service attacks.

More precisely, the invention relates to such a method in which, when setting up a communication session between a client and the server, the setting up of that session being requested by the client for the provision of a service, at least some of the following data is exchanged:

the server receives a request to provide service sent by the client;

the server sends an agreement to provide service to the client;

the server waits for an acknowledgement from the client of the agreement to provide service for a time period determined beforehand by the server.

As a general rule, the server can manage a plurality of requests to provide service. To this end it includes a buffer memory in which it stores requests that it receives pending the corresponding acknowledgements, which should reach it before the predetermined time period expires. This time period runs from the sending by the server of the agreement to provide service.

The buffer memory has a predetermined size and can therefore store a predetermined maximum number of requests to provide service.

A denial of service attack consists in using the protocol for setting up a communication session with the server described above:

to transmit a request to provide service to the server to be attacked;

to receive the agreement to provide service from the server; and

to avoid sending the acknowledgement awaited by the server.

Thus a malicious user can send a large number of synchronized denial of service attacks to the server from one or more client terminals called “zombies” so as to fill up the buffer memory of the server quickly. The server can then no longer receive new requests to provide service, for example from other, non-malicious users, and can no longer fulfill its service provision function.

A first solution, of preventive type, for protecting a server against such attacks consists in increasing the size of its buffer memory or reducing the time period determined beforehand by the server for which it waits for the acknowledgement that ought to be sent by the client.

Increasing the size of the buffer memory is not a satisfactory solution since the size of the buffer memory is itself limited by the overall memory available on the server. Similarly, reducing the predetermined time to wait for an acknowledgement is not satisfactory because this may be harmful to users who, although not malicious and actually requiring a service from the server, do not have a connection with a bit rate that is sufficient to be able to send an acknowledgement to the server in an excessively short a time period.

Another solution, of reactive type, for protecting a server against such attacks consists in diverting all data sent to the attacked server to another server, generally called a “black hole”, as soon as attacks on the server are detected, so that it is the black hole that receives all the attacks rather than the server itself. The function of the black hole is to receive the data and to destroy it without processing it.

However, that solution cannot process differently malicious attacks and real requests to provide service sent by legitimate clients. Moreover, if that solution is applied, the attack may be considered to have succeeded since the attacked server can no longer provide the service.

Another solution, described in the document US 2004/0015721, consists in using intermediate equipment between the client and the server. The function of the intermediate equipment is to behave like the server vis-à-vis the client and like the client vis-à-vis the server.

As a result, the client in fact sets up a first communication session with the intermediate equipment, after which, if the first session is set up correctly, the intermediate equipment sets up a second communication session with the server.

The effect of that solution is that it is no longer the server, but rather the intermediate equipment, that receives attacks from a malicious client, however it is necessary to manage two communication sessions, one between the client and the intermediate equipment, and the other between the intermediate equipment and the server, rather than a single communication session between the client and the server.

The invention aims to improve the existing methods of protecting a server against denial of service attacks by providing a method capable of protecting a server against such attacks at least as effectively as the method disclosed in the document US 2004/0015721 but without requiring two communication sessions to be managed.

The invention therefore consists in a method of protecting a server against denial of service attacks using a protocol whereby setting up a communication session between a client and the server is requested by the client for the provision of a service, this method comprising the following steps:

a) intercepting a request to provide service sent by a client and addressed to the server so that the request is not transmitted to the server;

b) checking if the client is present in a table of clients judged reliable;

c) if the client is present in the table, forwarding the request to the server;

d) if the client is absent from the table, executing the following steps:

e) sending an agreement to provide service to the client;

f) in the event of reception from the client under a predetermined condition of an acknowledgement of the agreement, listing the client in the table and sending the client a signal to inform it that setting up the communication session has failed.

Steps b) to f) of this method are executed by the intermediate equipment, for example.

Under such circumstances, the intermediate equipment maintains an up-to-date table including a list of clients judged reliable. If a client is listed in the table, the intermediate equipment does not interrupt the setting up of a session requested by that client. However, if the client is not listed in the table, i.e. if the client is not judged reliable by the intermediate equipment, the setting up of the session is automatically interrupted.

Thus only one communication session is managed, the session to be set up between the client and the server, the intermediate equipment being involved only to interrupt the setting up of the session requested by the client if that is appropriate.

Note that if the condition determined beforehand by the intermediate equipment is satisfied, the setting up of the session is interrupted by the intermediate equipment and not diverted to another terminal. Denial of service attacks therefore have no effect on the server or on any other terminal.

In one particular embodiment of the invention, the predetermined condition is that the acknowledgement is received within a predetermined time period after the sending of the agreement to provide service.

In this embodiment, the client is listed in the table by the intermediate equipment if, for example, when setting up a previous session, the client sent an acknowledgement of an agreement to provide service sent by the intermediate equipment within the time period determined beforehand by the server.

Under such circumstances, each first attempt at setting up a communication session with the server by a client fails because the intermediate equipment has not yet listed that client in the table. In fact, this first session set-up attempt is a test managed by the intermediate equipment to verify that the client actually sends an acknowledgement in the time period required by the server. If the client sends the acknowledgement in good time, it is then considered as being a reliable client and is listed in the table by the intermediate equipment. The fact that the client sends the acknowledgement in good time proves that the client is not using a usurped IP address (the technique routinely employed in an attack). Thus, in accordance with the invention, on a second attempt by this client to set up a communication session with the server, the intermediate equipment will not interrupt the setting up of the session.

The criterion determined beforehand by the intermediate equipment is preferably a time period to wait for the agreement acknowledgement that is shorter than that determined beforehand by the server.

This embodiment is particularly beneficial if the requests to provide service are sent by clients that access the server via a high bit rate network, i.e. a network with a shorter time delay than the Internet. With a high bit rate, the time period for sending an agreement acknowledgement may be shorter. The fact that this shorter time period is imposed by the intermediate equipment and not by the server enables other requests to provide service from other clients having access at lower bit rates to be received anyway.

In another embodiment of the invention, the predetermined condition is that the acknowledgement contains a value equal to a unique key previously introduced into the agreement to provide service.

The unique key is preferably a function of the client and is calculated a first time at the time of sending the agreement to provide service and a second time at the time of receiving the acknowledgement.

This embodiment is particularly advantageous since it is not necessary for the intermediate equipment to save requests to provide service in its buffer memory for a predetermined time period pending the corresponding acknowledgements. In fact, in this embodiment, the intermediate equipment sends clients who have sent a request to provide service an agreement to provide service without saving the original request. When it receives an acknowledgement of an agreement to provide service, it compares the value contained in that acknowledgement with a key that it calculates. Thus the intermediate server is much less vulnerable to denial of service attacks since its processing capacity is not limited by its buffer memory.

By using the intermediate equipments, the remote server is less heavily loaded, since the calculation load necessary for verifying the reliability of clients is distributed between different intermediate equipments. Moreover, those intermediate equipments are preferably situated in the vicinity of the clients, so that the network connecting the remote server to the intermediate equipments is not congested by the various messages sent during a denial of service attack.

The invention also consists in a computer program for protecting a server against denial of service attacks using a protocol according to which setting up a communication session between a client and the server is requested by the client for the provision of a service, the program containing instructions for executing steps b) to f) defined above.

The invention further consists in a device for protecting a server against denial of service attacks using a protocol whereby setting up a communication session between a client and the server is requested by the client for the provision of a service, the device comprising means for executing steps b) to f) defined above.

The means for executing steps b) to f) optionally comprise a computer program according to the invention.

Finally, the invention also consists in a system for protecting a server against denial of service attacks using a protocol according to which setting up a communication session between a client and the server is requested by the client for the provision of a service, the system including a server adapted to provide a service liable to be requested by a client, characterized in that the system includes an intermediate equipment in the form of a protection device as defined above.

A server protection system according to the invention may further have the feature whereby the intermediate equipment is a firewall disposed between the server and an access network from the client to the server.

The invention will be better understood after reading the following description, which is given by way of example only and with reference to the appended drawings, in which:

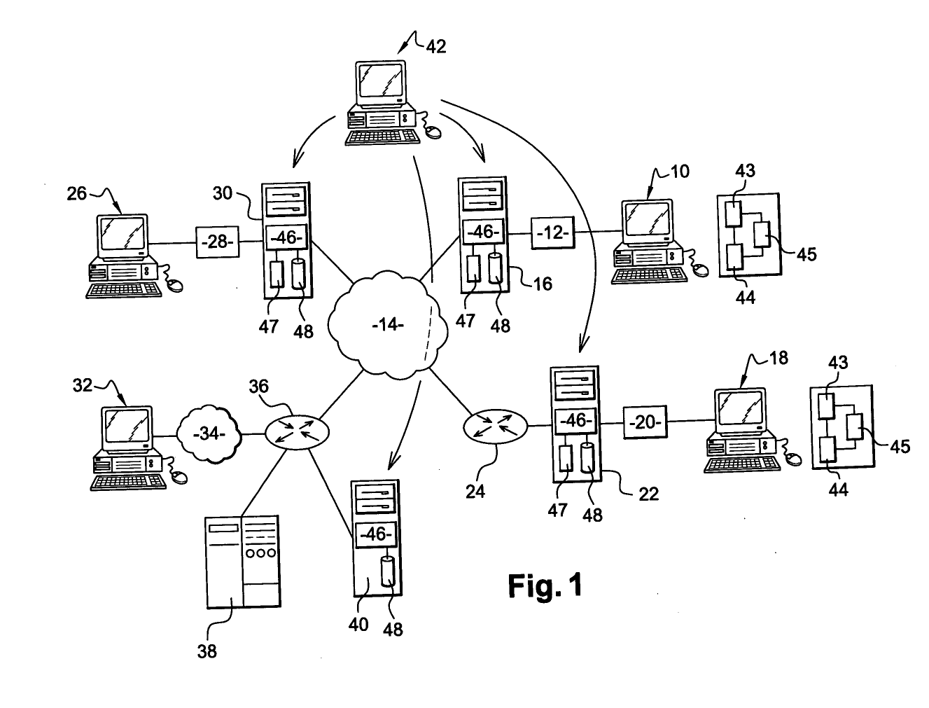

FIG. 1 represents diagrammatically the general structure of an installation including a system according to one possible embodiment of the invention;

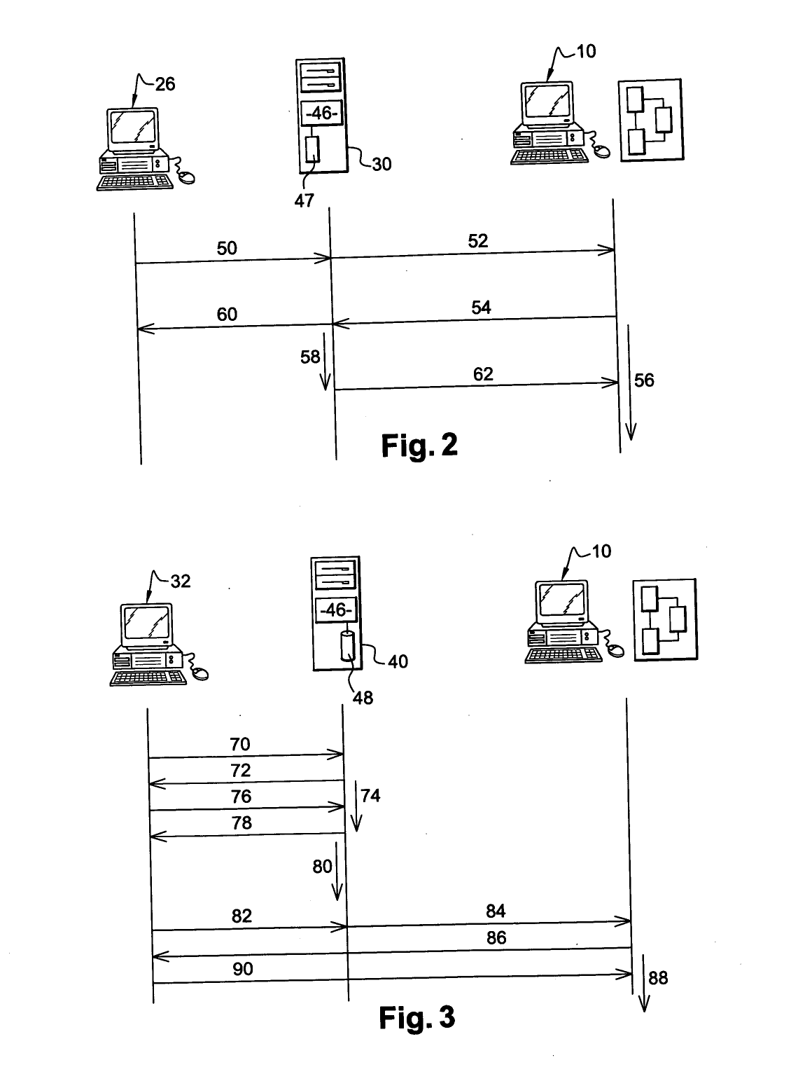

FIG. 2 represents the successive steps of a server protection method according to a first embodiment of the invention;

FIG. 3 represents the successive steps of a server protection method according to a second embodiment of the invention;

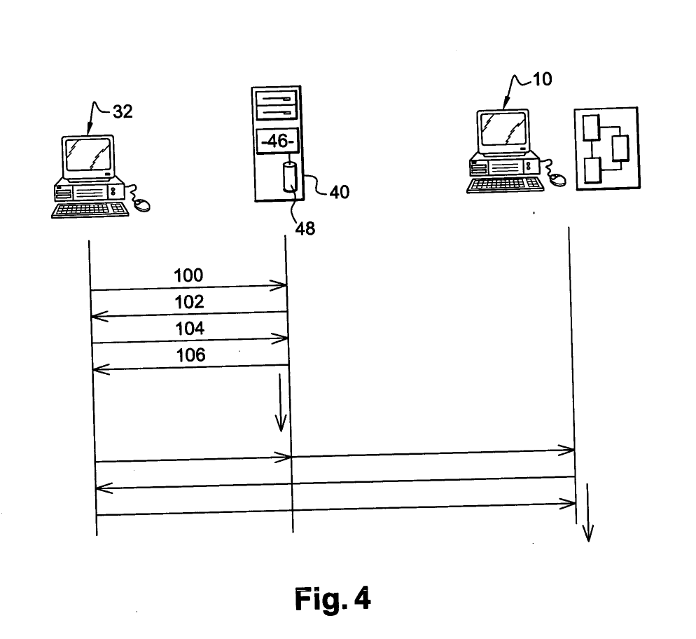

FIG. 4 represents the successive steps of a server protection method according to a third embodiment of the invention.

The installation represented in FIG. 1 includes a first server 10 adapted to provide a predetermined service to different clients.

The server 10 is connected to a high bit rate network 12, for example an ADSL connection itself connected to an operator network 14. Intermediate equipment 16 may be disposed at the interface between the operator network 14 and the high bit rate network 12. This intermediate equipment 16 is a firewall, for example.

The installation includes a second server 18 also adapted to provide a predetermined service to different clients.

This server 18 is connected to a private local area network 20 itself connected to the operator network 14. Intermediate equipment 22 and a router 24 may be disposed at the interface between the operator network 14 and the high bit rate network 12. The intermediate equipment 22 is a firewall, for example, like the intermediate equipment 16.

The installation represented in FIG. 1 further includes a first client terminal 26 able to request the provision of a service by the server 10 or the server 18. This client terminal 26 is connected to a high bit rate network 28, for example identical to the high bit rate network 12, i.e. an ADSL connection. This high bit rate network 28 is itself connected to the operator network 14 via an intermediate equipment 30 such as a firewall.

Finally, the installation includes a second client terminal 32, also able to request the provision of a service by the server 10 or the server 18. It is connected to a packet-switched data transmission network 34 such as the Internet. The Internet 34 is itself connected to the operator network 14 via a router 36 connected directly to a control platform 38 and to intermediate equipment 40. The intermediate equipment 40 is a firewall, for example, like the intermediate equipments 16, 22 and 30.

The intermediate equipment 16, 22, 30 and 40 are all managed by a conventional system 42 under the control of the operator of the network 14.

To enable the provision of a service to requesting client terminals, such as the terminals 26 and 32, the server 10 includes means for setting up a communication session with remote terminals.

More precisely, the server 10 includes means 43 for receiving a request to provide service sent by any client. It further includes means 44 for sending an agreement to provide service to the client that sent it the request. Finally, it includes means 45 for triggering a predetermined time period for waiting for an acknowledgement of the agreement that it has just sent from the client that sent it the request. The server 18 also includes the same means 43, 44 and 45 as the server 10.

To enable protection of the servers 10 and 18 against denial of service attacks coming from the client terminals 26 and 32, the intermediate equipment 16, 22, 30 and 40 includes means 46 for interrupting the setting up of a session requested by a client if a criterion determined beforehand by the intermediate equipment is satisfied during the exchange of data necessary for setting up a session.

For example, the criterion determined beforehand by the intermediate equipment is a time to wait for an acknowledgement that is shorter than the time determined beforehand by the server 10 or 18. To this end, the intermediate equipment concerned includes means 47 for triggering this short time period.

As a general rule, the waiting time period implemented on a server such as the server 10 or 18 is of the order of a few tens of seconds, whereas the short time period of the intermediate equipment can be adjusted to only three seconds.

This short time period criterion is advantageously implemented in intermediate equipment situated at the interface of networks with short time delays or low loads because it imposes a shorter response time on a client. In contrast, intermediate equipment situated at the interface of two networks at least one of which has a bit rate comparable to that of the Internet should not apply this criterion for interrupting session set-up.

It is for this reason that the intermediate equipment 16, 22 and 30 in the embodiment represented in FIG. 1 each include means 47 for triggering a short time period, but not the intermediate equipment 40.

The criterion determined beforehand by the intermediate equipment may also be the absence of a client from a table kept up to date by the intermediate equipment when it intercepts a request to provide service from that client. Such a table is then stored in storage means 48 that are regularly updated by the intermediate equipment concerned.

This criterion may be implemented on each intermediate equipment 16, 22, 30 and 40.

In a preferred embodiment described in more detail with reference to FIG. 3, the client is listed in the table by the intermediate equipment if, when setting up a previous session, the client sent an acknowledgement of an agreement to provide service sent by the intermediate equipment within the time period determined beforehand by the server whose client requested the provision of service.

A first embodiment of a method according to the invention of protecting the server 10 or 18 is described next with reference to FIG. 2 in the context of an exchange of data between the client 26 and the server 10. This process is advantageously implemented by the intermediate equipment 30 situated at the interface between the operator network 14 and the high bit rate network 28.

During a first step 50 of this method, the client terminal 26 sends via the high bit rate network 28 a request to provide service that is addressed to the server 10. That request is intercepted by the intermediate equipment 30 and then passed to the server 10 through the operator network 14 and the high bit rate network 12 during a step 52.

During the next step 54, the server 10 sends an agreement to provide service to the client terminal 26. During a step 56, sending this agreement activates the means 45 for triggering the time period determined beforehand by the server 10. The agreement to provide service sent by the server 10 is intercepted by the intermediate equipment 30, which triggers the activation of the means 47 for triggering the short time period determined beforehand by the intermediate equipment during a step 58. Once this shorter waiting time period has been triggered by the intermediate equipment 30, the agreement to provide service reaches the client terminal 26 via the high bit rate network 28 during a step 60.

If, on expiry of the short time period triggered by the intermediate equipment 30, the intermediate equipment has still not received an acknowledgement that should have been sent by the client terminal 26, the intermediate equipment 30 interrupts the setting up of the session requested by the client terminal 26 during a step 62 in which it sends the server 10 a signal informing it of this interruption. Thus the server 10, which had been saving the request to provide service from the client terminal 26 in its buffer memory, can free that memory before the expiry of its own waiting time.

Any denial of service attacks sent from the terminal 26 are therefore neutralized by the intermediate equipment 30, without affecting the server 10, which can receive other requests to provide service from other client terminals.

Of course, after the step 60 in which the client terminal 26 receives the agreement to provide service, if it sends an acknowledgement to the server 10 before the expiry of the short time period imposed by the intermediate equipment 30, setting up the communication session requested by the client terminal 26 is not interrupted.

A second embodiment of a method according to the invention of protecting the server 10 or 18 is described next with reference to FIG. 3 in the context of an exchange of data between the client 32 and the server 10. This method is advantageously implemented by the intermediate equipment 40 situated at the interface between the operator network 14 and the Internet 34.

In this method, the client terminal 32 sends a first request to provide service that is addressed to the server 10. This first request to provide service is sent during a step 70. It is transmitted by the Internet 34 and reaches the router 36 which, under the control of the control platform 38, redirects it to the intermediate equipment 40 so that the intermediate equipment can intercept it. The intermediate equipment 40 receives this request to provide service and checks if the identification number corresponding to the client terminal 32 is absent from a table that it keeps up-to-date.

The number will indeed be absent, since this request is the first that the client terminal sends to the server 10. The intermediate equipment 40 therefore intercepts the request for setting up the session from the client terminal 32 and responds to that request, instead of the server 10, during a step 72 of sending the client terminal 32 an agreement to provide service. The intermediate equipment intercepts the request and prevents its transmission to the server 10. The sending of the agreement to provide service by the intermediate equipment 40 triggers a time period determined beforehand by the intermediate equipment for waiting for an acknowledgement of the agreement, this time period corresponding to the waiting time period of the server 10.

During the next step 76, the client terminal 32 sends an acknowledgement of the agreement that it has received. As before, that acknowledgement is redirected to the intermediate equipment 40 by the router 36 under the control of the control platform 38. If this acknowledgement reaches the intermediate equipment 40 before the expiry of the waiting time period triggered in the step 74, this triggers the listing of the client terminal 32 in a table kept up-to-date by the intermediate equipment 40. This listing of the client terminal 32 in the table of the intermediate equipment 40 attests that this client terminal 32 sent a request to provide service that was not a denial of service attack. This client terminal is therefore considered to be a trusted terminal by the intermediate equipment 40. The listing in the table of the intermediate equipment 40 may be temporary, i.e. subject to a time-out.

After it has received the acknowledgement sent by the client terminal 32 during the step 76, the intermediate equipment 40 interrupts the session with the client terminal that it set up instead of the server 10 and sends a signal to inform the client terminal 32 that the connection has failed during a step 78. In fact, the server 10 cannot take over this session since, to set up a communication session between the client terminal 32 and the server 10, the server 10 must itself generate, at the time of sending the agreement, the sequence number of the acknowledgement that it receives.

Later, the client terminal 32 sends a second request to provide service that is addressed to the server 10. This request to provide service is sent by the client terminal 32 during a step 82. This request to provide service is intercepted by the intermediate equipment 40 which, as before, checks if the client terminal 32 is absent from the table that it keeps up-to-date. If this is not so, then the request to provide service sent by the client terminal 32 during the step 82 is forwarded and is received by the server 10 during a step 84. Then, during a step 86, the server 10 sends an agreement to provide service to the client terminal 32 and, during a step 88, triggers a time period for waiting for an acknowledgement from the client terminal 32.

If, during a step 90, as shown in FIG. 3, the client terminal 32 sends an acknowledgement before the expiry of the time period imposed by the server 10, the setting up of the communication session between the client terminal 32 and the server 10 may continue without being interrupted by the intermediate equipment 40.

It will be noted that, in this second embodiment of a method according to the invention, the server protected by the intermediate equipment is not solicited at all if it is the victim of a denial of service attack.

A third embodiment of a method according to the invention of protecting the server 10 or 18 is described next with reference to FIG. 4, in the context of an exchange of data between the client 32 and the server 10. This method is advantageously executed by the intermediate equipment 40 situated at the interface between the operator network 14 and the Internet 34.

In this method, the client terminal 32 sends a first request to provide service that is addressed to the server 10. This first request to provide service is sent during a step 100. It is transmitted via the Internet 34 and reaches the router 36 which, under the control of the control platform 38, redirects it to the intermediate equipment 40 so that the intermediate equipment can intercept it. The intermediate equipment 40 receives this request to provide service and checks if the identification number corresponding to the client terminal 32 is absent from a table that it keeps up-to-date.

The number will indeed be absent, since this request is the first that the client terminal sends to the server 10. The intermediate equipment 40 therefore intercepts the request from the client terminal 32 to set up of the session.

The request to provide service sent by the client 32 includes an identifier of that client, for example the client's IP address. On receiving this request to provide service, the intermediate equipment 40 calculates by means of a predefined algorithm a key that is a function of the IP address of the client 32. A secret algorithm is used for this so that only the intermediate equipment 40 is capable of calculating this key.

During the next step 102, the intermediate equipment 40 responds to the request instead of the server 10, sending the client terminal 32 an agreement to provide service. That agreement to provide service contains a value equal to the key that the intermediate equipment has calculated. For example, the intermediate equipment 40 may include this value in the agreement to provide service in the form of a sequence number, which is a field conventionally used in packet-switched data transmission protocols such as the TCP.

In contrast to the embodiment previously described, the intermediate equipment 40 does not save the request to provide service and does not trigger a time-out. Thus it does not fill up its buffer memory.

During the next step 104, the terminal 32 sends an acknowledgement of the agreement that it has received. To specify the number of the packet that the client terminal has received, it includes in its acknowledgement the sequence number of the agreement to provide service. That sequence number corresponds to the value equal to the unique key.

As before, this acknowledgement is redirected to the intermediate equipment 40 by the router 36 under the control of the control platform 38.

On reception of this acknowledgement, the intermediate equipment 40 extracts from it the IP address of the client terminal 32 and the value that it contains.

During the next step, the intermediate equipment 40 calculates a key from the IP address that it has extracted from the acknowledgement and then compares the value extracted with the key just calculated.

If the two keys are identical, the intermediate equipment considers that the client terminal 32 is reliable and that it can then initiate the listing of the client terminal 32 in the table that is kept up-to-date. This listing of the client terminal 32 in the table of the intermediate equipment 40 attests that the client terminal 32 has sent a request to provide service that is not a denial of service attack.

Accordingly, in this embodiment, the intermediate equipment can test the reliability of a client terminal 32 that has sent a request to provide service without needing to fill its buffer memory temporarily.

Then, during a step 106, the intermediate equipment 40 sends the client terminal 32 a signal to inform the client terminal 32 that the connection has failed.

Later, the client terminal 32 sends a second request to provide service that is addressed to the server 10. As the client terminal 32 has been added to the table kept up-to-date by the intermediate equipment 40, this request is transmitted to the server 10 which agrees to set up the session.

The subsequent steps are identical to those described in relation to the second embodiment.

It will be noted that, in this third embodiment, the server 10 is protected by the intermediate equipment since it is not solicited at all by a denial of service attack. Moreover, it will be noted that this intermediate equipment cannot be the victim of a denial of service attack either since it does not save requests to provide service.

Moreover, the method that does not save requests to provide service may be implemented directly in the server. In fact, there is no risk of the buffer memory of the server being filled quickly and the server is therefore protected against denial of service attacks. Under such circumstances, by way of an exception to the general definition of the invention, the request is actually transmitted to the server but the server takes account of it only from the step of transmission of the request to the server.

It is clearly apparent that a system and a method according to the invention effectively protect a server against denial of service attacks without necessitating the management of a plurality of communication sessions.

1. A method of protecting a server (10, 18) against denial of service attacks using a protocol whereby setting up a communication session between a client (26, 32) and the server is requested by the client for the provision of a service, this method comprising the following steps:
a) intercepting a request to provide service sent by a client and addressed to the server (10) so that the request is not transmitted to the server;
b) checking if the client is present in a table of clients judged reliable;
c) if the client is present in the table, forwarding the request to the server;
d) if the client is absent from the table, executing the following steps:
e) sending (72) an agreement to provide service to the client;
f) in the event of reception from the client under a predetermined condition of an acknowledgement of the agreement, listing the client in the table and sending (78) the client a signal to inform it that setting up the communication session has failed.

2. A method according to claim 1, wherein the predetermined condition is that the acknowledgement is received within a predetermined time period after the sending of the agreement to provide service.

3. A method according to claim 1, wherein the predetermined condition is that the acknowledgement contains a value equal to a unique key previously introduced into the agreement to provide service.

4. A method according to claim 3, wherein the unique key is a function of the client and is calculated a first time at the time of sending the agreement to provide service and a second time at the time of receiving the acknowledgement.

5. A computer program for protecting a server against denial of service attacks using a protocol according to which setting up a communication session between a client and the server is requested by the client for the provision of a service, the program containing instructions for executing steps b) to f) of claim 1.

6. A device for protecting a server against denial of service attacks using a protocol whereby setting up a communication session between a client and the server is requested by the client for the provision of a service, the device comprising means for executing steps b) to f) of claim 1.

7. A device according to claim 6, wherein the means for executing steps b) to f) comprise a computer program for protecting a server against denial of service attacks using a protocol according to which setting up a communication session between a client and the server is requested by the client for the provision of a service the program containing instructions for executing steps b) to f).

8. A system for protecting a server against denial of service attacks using a protocol according to which setting up a communication session between a client (26, 32) and the server is requested by the client for the provision of a service, the system including a server (10, 18) adapted to provide a service liable to be requested by a client (26, 32), characterized in that the system includes an intermediate equipment (16, 22, 30, 40) in the form of a protection device according to claim 6.

9. A server protection system according to claim 8, wherein the intermediate equipment (16, 22, 30, 40) is a firewall disposed between the server (10, 18) and an access network (28, 34) from the client (26, 32) to the server.

10. A system for protecting a server against denial of service attacks using a protocol according to which setting up a communication session between a client (26, 32) and the server is requested by the client for the provision of a service, the system including a server (10, 18) adapted to provide a service liable to be requested by a client (26, 32), characterized in that the system includes an intermediate equipment (16, 22, 30, 40) in the form of a protection device according to claim 7.

11. A server protection system according to claim 8, wherein the intermediate equipment is disposed between the client and the server, in the vicinity of the client.

12. A server protection system according to claim 9, wherein the intermediate equipment is disposed between the client and the server, in the vicinity of the client.
